(19) United States
(12) Patent Application Publication
(10) Pub. No.: US 2003/0208454 A1
(43) Pub. Date: Nov. 6, 2003

(54) Method and system for populating a database for further medical characterization

(76) Inventors: Hugh Y. Rienhoff JR., San Carlos, CA (US); James R. Kean, Hillsborogh, CA (US); Hywel B. Jones, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/805,619

(22) Filed: Mar. 13, 2001

Related U.S. Application Data
(60) Provisional application No. 60/190,359, filed on Mar. 16, 2000.
(60) Provisional application No. 60/190,360, filed on Mar. 16, 2000.
(60) Provisional application No. 60/209,843, filed on Jun. 6, 2000.
(60) Provisional application No. 60/209,876, filed on Jun. 6, 2000.

(51) Int. Cl. G06F 17/30; G06F 17/60

(52) U.S. Cl. 707/1; 705/2; 705/3; 707/10; 707/104.1

(57) ABSTRACT

A database is populated for further medical characterization through a world wide network of computers. The database is populated with a plurality of user health information from a plurality of users. The user health information includes genetic data and phenotypic data for a user. The database is populated at least in part through browsing activities of the plurality of users on the world wide network of computers.

### CROSS-REFERENCES TO RELATED APPLICATIONS

This application claims priority to U.S. Provisional Application Nos. 60/190,359 and 60/190,360, filed Mar. 16, 2000, as well as 60/209,843 and 60/209,876, filed Jun. 6, 2000, the teachings of which are incorporated herein by reference in their entirety for all purposes.

### BACKGROUND OF THE INVENTION

The present invention generally relates to database systems. More particularly, the present invention relates to populating a database with phenotypic and genotypic information from a plurality of individuals. Each individual provides information (e.g., family history, lifestyle, clinical and medical history, therapies, phenotype) that is capable of being associated with additional information such as biological information from a biological sample (e.g., DNA information, etc.) from that individual. Such information can be aggregated and correlations uncovered to provide the basis for product development such as diagnostics, therapeutic selection, behavior modification, drug discovery, and the like.

In general, bioinformatics is the study and application of computer and statistical techniques to the management of biological information, including nucleic acid sequencing. The development of systems and methods to search these databases quickly, to analyze the nucleic acid sequence information, and to predict protein sequence, structure and function from DNA sequence data has become increasingly important. This is especially true for the data collected in the human genome project, which constitutes huge volumes of information. To access this data, molecular biologists and genetic researchers require advanced quantitative analyses, database comparisons tools, expert systems and computational algorithms that allow the exploration of the relationships between the stored gene sequences and phenotype.

Correlation of the genetic information stored in these databases is useful for product development such as diagnostics, therapeutic selection, behavior modification, drug discovery, and the like. Such information is of significant interest to the pharmaceutical industry to assist in the evaluation of drug efficacy, pharmacogenomics and drug resistance. To make genomic information accessible, database systems have been developed that store the genomes of many organisms. The information is stored in relational databases that can be employed to determine relationships among gene sequences within the same genome and among different genomes.

Association and comparison of the stored genetic information to other information such as phenotype is particularly important. Systems and methods are needed to populate databases with information from large numbers of individuals with diverse backgrounds. Such databases may enable discovery of correlations between genotypes and phenotypes, and vise versa. The present invention remedies these and other needs.

### SUMMARY OF THE INVENTION

According to the present invention, a technique for populating a database for medical characterization through a worldwide area network of computers is provided. In an exemplary embodiment, the present invention provides systems and methods for gathering information from many individuals. Each individual provides information (e.g., family history, lifestyle, clinical and medical history, therapies, phenotype) that is capable of being associated with additional information such as biological information from a biological sample (e.g., DNA information, etc.) from that individual. Such information can be aggregated and correlations uncovered to provide the basis for product development such as diagnostics, therapeutic selection, behavior modification, drug discovery, etc.

In a specific embodiment according to the invention, a method for populating a database for further medical characterization through a world wide network of computers is provided. The method comprises populating a database with a plurality of user health information from a plurality of users. The user health information includes genetic data and phenotypic data for a user. Wherein, the database is populated at least in part through browsing activities of the plurality of users on the world wide network of computers.

In another specific embodiment, a system for populating a database for further medical characterization through a world wide network of computers is provided. The system includes a module for populating a database with a plurality of user health information from a plurality of users. The user health information including genetic data and phenotypic data for a user. Wherein, the database is populated at least in part through browsing activities of the plurality of users on the world wide network of computers.

In yet another specific embodiment, a method for populating a database with phenotypic data and genotypic data of a plurality of users for further medical characterization through a world wide network of computers is provided. The method comprises inquiring for phenotypic data from each of a plurality of users, and inquiring for biological material from a subset of the plurality of users. The method also comprises populating a database with received phenotypic data, and populating the database with genotypic data derived from received biological samples. The method additionally comprises aggregating the phenotypic data and genotypic data.

Numerous advantages are achieved by way of the present invention over conventional techniques. Some embodiments of the invention can be used to provide a select group of people with specific or desirable characteristics for a clinical trial for a pharmaceutical or drug product or medical procedure. Additionally, some embodiments of the invention can be used to discover diagnostic and prognostic procedures. Further, some embodiments of the invention can be used to discover or improve patient treatment using therapeutics and/or drugs and/or vaccines. Depending upon the embodiment, one or more of the advantages are achieved.

These and other embodiments of the present invention, as well as its advantages and features, are described in more detail in conjunction with the figures and text below.

### BRIEF DESCRIPTION OF THE DRAWINGS

FIG. 1 is a simplified overall system diagram according to an embodiment of the present invention;

FIG. 2 is a simplified diagram of a representative computer system according to some embodiments of the present invention;

FIG. 3 is a simplified diagram of basic subsystems in a computer system, such as the computer system illustrated in FIG. 2;

FIG. 4 is a simplified overall system diagram according to an embodiment of the present invention;

FIG. 5 is a simplified flow diagram of a method according to an embodiment of the present invention;

FIG. 6 is a simplified flow diagram of a method according to another embodiment of the present invention;

FIGS. 7A and 7B are a simplified flow diagram of a method according to yet another embodiment of the present invention;

FIG. 8 is a simplified flow diagram of a method according to another aspect of the present invention;

FIG. 9 is a simplified flow diagram of a method according to yet another aspect of the present invention; and

FIG. 10 is a simplified flow diagram of a method according to another embodiment of the present invention.

### DESCRIPTION OF THE SPECIFIC EMBODIMENTS

In understanding the present invention, it may assist the reader the understand the following terms, which are defined below.

Phenotype: This term is defined by any observable or measurable parameter, either at a macroscopic or system level (e.g., hair color, hair pattern, organ function, age, ethic origin, weight, level of fat, and the like) or microscopic or even cellular or molecular level, (e.g., organ function, cellular organization, mRNA, intermediary metabolites, and the like). Phenotype can also be defined as a behavior pattern, sleep pattern, anger, hunger, athletic ability. There can be many other types of phenotypes, depending upon the application, which should not unduly limit the scope of the claims herein.

Genotype: This term refers to a specific genetic composition of a specific individual organism, for example, whether an individual organism has one or more specific genetic variants up to all the variations in that individual's genome, for example, whether the individual is a carrier of a sickle cell anemia genetic variant and other genetic variations that influence the disease. The example is merely illustrative and is not intended to limit the invention defined by the scope of the claims herein.

The present invention provides, inter alia, methods and systems for populating one or more databases with phenotypic and/or genotypic information from a large group of individuals using a worldwide network of computers. The present invention involves individual users accessing a web site. The web site offers information on health-related issues and a variety of diseases and medical conditions. The individual users can learn more about these diseases and medical conditions through browsing activities on the web site. Additionally, users are invited to submit phenotypic data via the web site. This data may be used to populate a database. Users may also be invited to submit a biological sample. Phenotypic and genotypic data may be extracted from the biological sample and such data may also be used to populate the database. Thus, a rich and diverse phenotypic/genotypic database may be developed.

Such a database may be used to identify populations of individuals for medical characterization. For example, populations may be identified by phenotypic characteristics (e.g., family history, lifestyle, clinical and medical history, therapies, phenotype, and the like) can be identified. Additionally, phenotypic data may be capable of being associated with additional information such as biological information from biological samples (e.g., DNA information, etc.) from individuals. Such information can be aggregated and correlations uncovered to provide the basis for product development such as diagnostics, therapeutic selection, behavior modification, drug discovery, and the like.

General System Overview

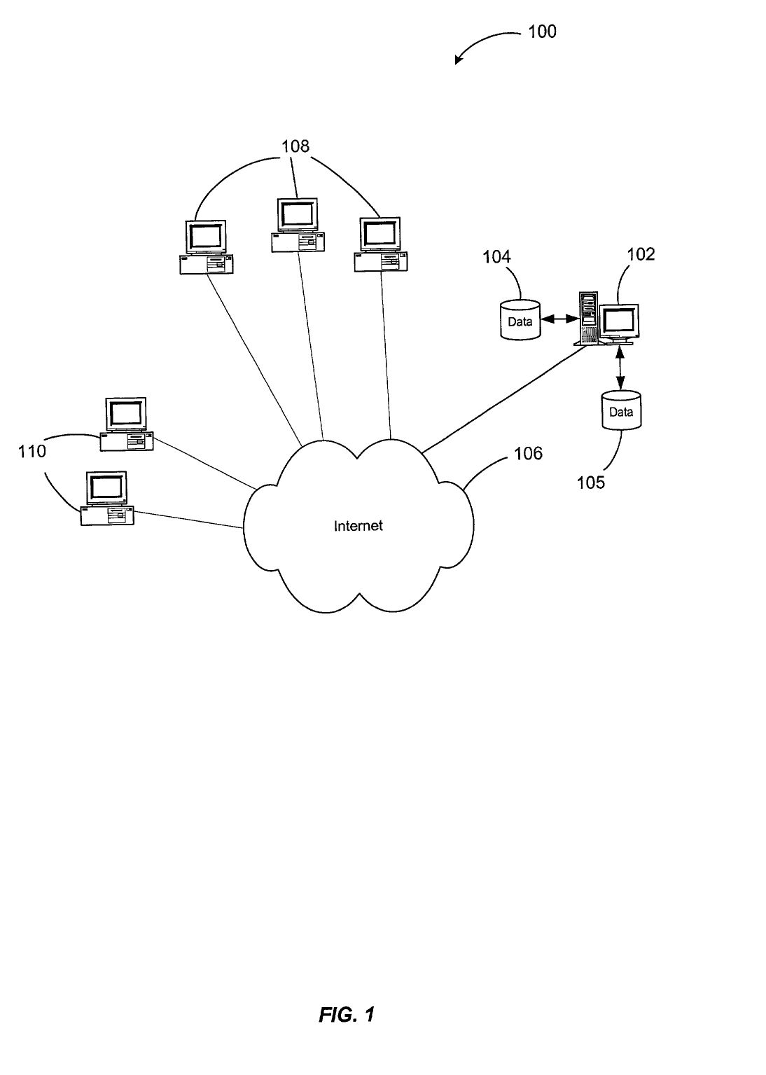

FIG. 1 is a simplified block diagram of a system according to an embodiment of the present invention. This diagram is used herein for illustrative purposes only and is not intended to limit the scope of the invention. One skilled in the art would recognize many other variations, alternatives, and modifications. FIG. 1 illustrates a system 100 for populating a secure database with genotypic and phenotypic data. The system 100 includes a server system 102 coupled with databases 104 and 105, and a wide area network 106. Also coupled with the wide area network 106 are a plurality of user computers 108. Wide area network 106 allows each of computers 102 and 108 to communicate with other computers and each other. The wide area network 106 may be an internet, the Internet, an intranet, an extranet, or the like. The term “Internet” as used hereinafter shall incorporate the terms “internet”, “intranet”, and “extranet”, and any references to the “Internet” shall be understood to reference an internet, intranet, extranet, or the like, as well.

In some embodiments, persons, via the user computers 108 and the Internet 106, may request of the server system 102 health related information. In response, the server system 102 may dispense such health related information to the user computers 102. As the provider of large amounts of valuable health related information, the server system 102 develops trusted relationships with persons. The trusted relationships in many instances are developed as a continuum, wherein, as the relationship is developed over time and interactions, so is the trust. As the server system 102 provides health related information to persons, the persons becoming willing partners and trusted relationships are developed.

The server system 102 may invite persons, via the Internet 106 and the user computers 108, to submit phenotypic data to the server system 102. Such phenotypic data may be stored in a database, such as the database 105. Moreover, the server system 102 may invite persons, via the Internet 106 and the user computers 108, to submit a biological sample. The biological sample may be analyzed (e.g., for genetic information), and such information derived from the biological sample may be stored in a database, such as the database 105. Because of the development of trusted relationships, persons will be more likely to favorably respond to such invitations.

The system may additionally include one or more subscriber computers 110 coupled with the Internet 106. Each subscriber computer 110 may be operated by for example, a physician, a health care provider, a pharmaceutical company, a diagnostic company, an academic institution, a public/government agency, or the like. The subscriber computers 110 may be provided access to the database 105 via the Internet 106. The access may include access to phenotypic and/or genetic information stored in the database 105. In one embodiment, subscriber computers 110 are only provided access to aggregate phenotypic and/or genetic information from the database 105 in order to protect the confidentiality of persons who have submitted phenotypic information and/or submitted biological samples from which phenotypic and/or genetic information was derived.

Server system 102 may comprise one or more servers. Server system 102 may be of any type suitable for hosting a web site. Server system 102 is typically coupled to the Internet 106 by a relatively high bandwidth transmission medium such as a T1 or T3 line. Server system 102 and database 104 store information and disseminate information to individual computers (e.g., 108 and 110) over the Internet 106. Methods according to the present invention can be used for identifying and inviting users to submit a biological sample for analysis in a networked environment 100. Server system 102 connected to the Internet 106 stores web pages on an electronic database 104. The concepts of “client” and “server,” as used in this application and the industry, are very loosely defined and, in fact, are not fixed with respect to machines or software processes executing on the machines. Typically, a server is a machine (e.g., 102) or process that is providing information to another machine or process, i.e., the “client,” (e.g., 108) that requests the information. In this respect, a computer or process can be acting as a client at one point in time (because it is requesting information) and can be acting as a server at another point in time (because it is providing information). Some computers are consistently referred to as “servers” because they usually act as a repository for a large amount of information that is often requested. For example, a WEB site is often hosted by a server computer with a large storage capacity, high-speed processor and Internet link having the ability to handle many high-bandwidth communication lines.

With respect to the electronic database 104, it generally contains web pages, questionnaires, and forms. The database 104 can be composed of a number of different databases. These databases can be located in one central repository, or alternatively, they can be dispersed among various distinct physical locations. These databases can be categorized and structured in various ways based on the needs and criteria of the database designer. Methods used to create and organize databases are commonly known in the art, for example, relational database techniques can be used to logically connect these databases.

In one embodiment, as shown in FIG. 1, the database 104 can be physically located separate from the processor. The database can reside on remote, distant servers on a local area network or the Internet. Under this arrangement, whenever any data are needed, the processor needs to access the necessary database(s) via a communication channel to retrieve the requisite data for analysis. For example, the processor can access and retrieve data from a remote database via a computer network such as a LAN or the Internet.

The embodiment shown in FIG. 1 also includes a database 105 for storing phenotypic and genotypic information. The database 105 can be composed of a number of different databases. These databases can be located in one central repository, or alternatively, they can be dispersed among various distinct physical locations. These databases can be categorized and structured in various ways based on the needs and criteria of the database designer. Methods used to create and organize databases are commonly known in the art, for example, relational database techniques can be used to logically connect these databases. In one embodiment, the database 105 is a secured database to protect the highly sensitive phenotypic and genotypic information of individuals. In another embodiment, the database 105 is not accessible from the Internet 106.

Databases 104 and 105 may be relational databases, distributed databases, object-oriented databases, mixed object-oriented databases, or the like. Database products with which the present invention may be implemented include, but are not limited to, IBM's DB2, Microsoft's Access and FoxPro, and database products from Oracle, Sybase, and Computer Associates.

Each of user computers 108 and subscriber computers 110 may be a desktop computer, a laptop computer, a workstation, a server, a mainframe, a personal digital assistant (PDA), a cellular phone, a two-way pager, or any other device capable of accessing information via the Internet 106. In some embodiments, each user computer 108 and subscriber computer 110 is linked with the Internet 106 via a communication link. The communication link may be established via a modem connected to a traditional telephone line, an ISDN line, a DSL link, a T1 line, a T3 line, a cable television line, a cellular link, a two-way pager link, a satellite link, or the like. In another embodiment, a user computer 108 and/or subscriber computer 110 may be linked directly to the server system 102 via a direct communications link. In some embodiments, each user computer 108 and subscriber computer 110 may include web browsing software, or the like for interacting with server system 102. In other embodiments, some or all of user computers 108 and subscriber computers 110 may include specialized and/or dedicated software for interacting with server system 102.

Developing Trust and Goodwill

Embodiments according to the present invention populate one or more databases with phenotypic and/or genotypic information of many individuals, and in some embodiments, individuals are invited to submit such information. This information is of an extremely personal nature and could potentially harm the individual, financially, or otherwise, if it were to be used for unintended purposes. Thus, individuals may be extremely reluctant to provide such information to a third party. Therefore, any system seeking to convince individuals to provide phenotypic and/or genotypic information for populating a database should engender a high degree of trustworthiness. If such trustworthiness does not exist, individuals will not likely respond invitations to provide their information.

Numerous embodiments of techniques for developing trust will now be discussed. It is to be understood that any one or more of these techniques may be employed, along with other like techniques for developing a trusted relationship.

An important technique for developing trust is to provide users with control and privacy rights over information they submit to the web site, and to make those rights known to the user. Trust is increased or maintained when policies of the web site take the patient's position in legal, and ethical issues. For example, users may be given strict control in determining who may access information they have submitted, which of the information may be accessed, and in what form the information is provided to others. For example, in some embodiments, user information may be provided to others in a form that is aggregated among many users and which does not identify the individual users. Also, users may be given the option, at any time, of having their information deleted from any databases as well as having any of their biological samples destroyed. Moreover, phenotypic and genotypic data submitted by users should be highly secured. Thus, in some embodiments, one or more of the database or databases that archive such information are not directly coupled to the Internet. Policies of the web site should be clearly posted and easily readable by lay persons.

One technique for developing trust is to provide, via the web site, reliable and valuable information regarding genetics, diseases, medical conditions, medications, etc. Such information may include educational materials such as definitions of terms and jargon, tutorials or articles on basic concepts, and the like. Such information may also include well-written articles on genetics, diseases linked to genetics, recent research, and the like that is understandable by lay persons. Trust is further developed if such articles are written and/or edited by well-respected authorities. Additionally, the information provided by the web site may include recent news concerning research and studies. Moreover, the information may be provided directly by the web site, or indirectly, such as, for example, via links to other web sites.

Another technique for developing trust is to provide, via the web site, a support framework so that groups of individuals interested or concerned about the same health-related issues, diseases, medical conditions, etc. can develop a community. For example, the web site could facilitate on-line meetings, provide message boards, chat rooms, and the like, which could be organized, for example, around specific diseases or medical conditions.

Yet another technique for developing trust is to provide, via the web site, online events relating to genetics, various health-related issues, diseases, medical conditions, related scientific, legal, ethical topics, etc. Such on-line events could include interviews or discussions involving experts such as physicians, researchers, etc., as well as educators, nurses, counselors, or celebrities or public figures. Transcripts of such on-line events could be archived for indefinite review by visitors to the web site. Such events should be punctual and well-moderated in order to show the professionalism of the web site and maintain or increase trust in the web site.

Still another technique for developing trust is to provide, via the web site, referrals of, for example, physicians, hospitals, counselors, clinics, testing laboratories, etc. In one embodiment, the web site provides access to a referral database that may be included, for example, in database 104 of FIG. 1. The referral database may include information such as names, locations, specialties, expertise, affiliations, services provided, methods of payment, policies (e.g., privacy policies) etc. In another embodiment, the web site could refer users to on-line counselors.

Another technique for developing trust is to provide tools, via the web site, that are useful and valuable. Such tools may include, for example, assessment tools for assessing diseases, medical conditions, etc. Another tool may allow visitors to the web site to interpret genetic information in the context of a family history. Such a tool may be in the form of, for example, a workbook, and provide users with, for example, a relative risk of developing a disease or medical condition based on family history, clinical information, etc. Yet another tool may permit users to build a secure on-line medical record, providing users with secure, but convenient access to their own medical information. Such a medical record should permit users to audit and maintain their own medical records. Additionally, users may be given the option to let selected others (e.g., their physicians) access their medical records. The medical record could also include or be linked to family history information, thus increasing the value of the medical-record tool. Medical records could be included, for example, in database 105 of FIG. 1. Tools provided by the web site should be easy to use, functional, and well-maintained in order to maintain or increase trust in the web site.

Additionally, the web site may provide users with information regarding ongoing medical studies, drug studies, genetic studies, etc., and may provide information on how a user can participate in such studies. The web site may provide such information via general postings viewable by all users, or provide information to selected users. For example, the information could be directed to individual users via email or web pages viewable to groups of users who have registered with the web site. In one embodiment, the web site may provide users the ability to volunteer for such studies via the web site. In another embodiment, certain users may be selected for invitations based on phenotypic and/or genotypic information they previously submitted.

The informational content, on-line events, referrals, tools, provided by the web site, as well as general policies of the web site could be overseen and directed by an editorial and/or advisory board. Such a board(s) should include well-respected authorities in order to add credibility and build trust in the web site. The board may include authorities in fields such as medicine, genetics, law, ethics, etc.

Computer Sub-Svstems

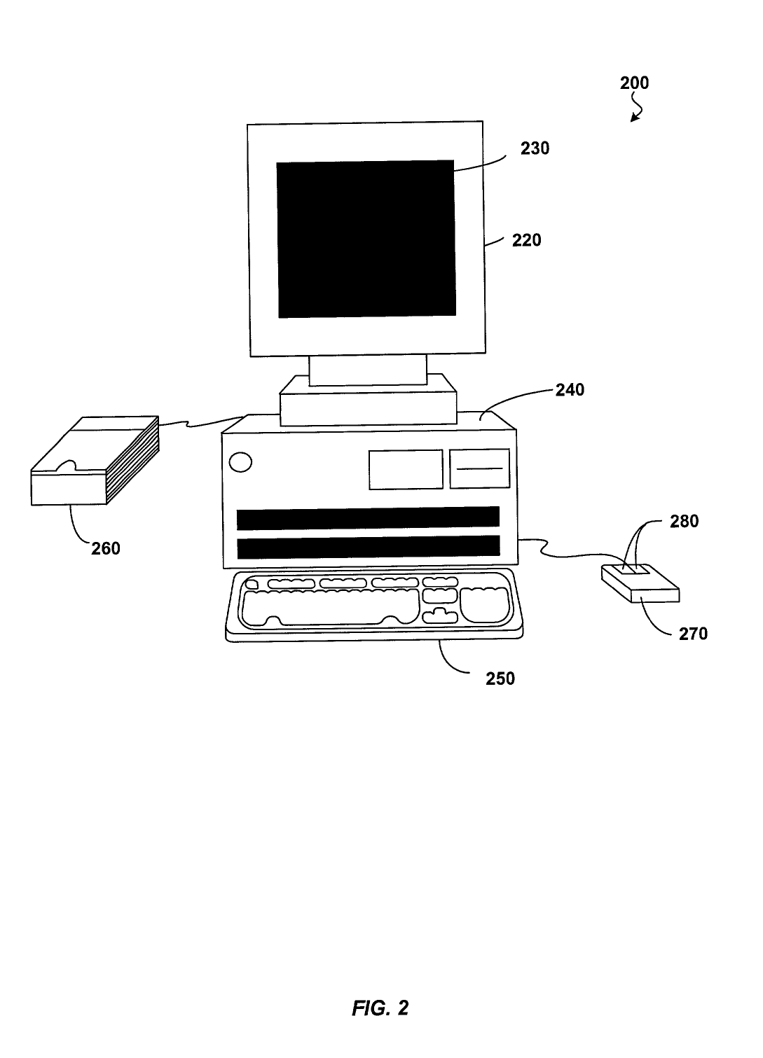

Embodiments according to the present invention can be implemented in a single application program such as a browser, or can be implemented as multiple programs in a distributed computing environment, such as a workstation, personal computer or a remote terminal in a client server relationship. FIG. 2 illustrates a representative computer system according to some embodiments of the present invention. In these embodiments, each of user computers 108, subscriber computers 110, and/or server system 102 may comprise one or more of computer system 200. This diagram is merely an illustration and should not limit the scope of the claims herein. One of ordinary skill in the art will recognize other variations, modifications, and alternatives

FIG. 2 shows computer system 200 that including display device 260, display screen 230, cabinet 240, keyboard 250, scanner 260 and mouse 270. Mouse 270 and keyboard 250 are representative “user input devices.” Other examples of user input devices are a touch screen, light pen, track ball, data glove and so forth. FIG. 2 is representative of but one type of system for embodying the present invention. It will be readily apparent to one of ordinary skill in the art that many system types and configurations are suitable for use in conjunction with the present invention.

Mouse 270 can have one or more buttons such as buttons 280. Cabinet 240 houses familiar computer components such as disk drives, a processor, storage device, etc. Storage devices include, but are not limited to, disk drives, magnetic tape, solid state memory, bubble memory, etc. Cabinet 240 can include additional hardware such as input/output (I/O) interface cards for connecting computer system 200 to external devices, external storage, other computers or additional peripherals.

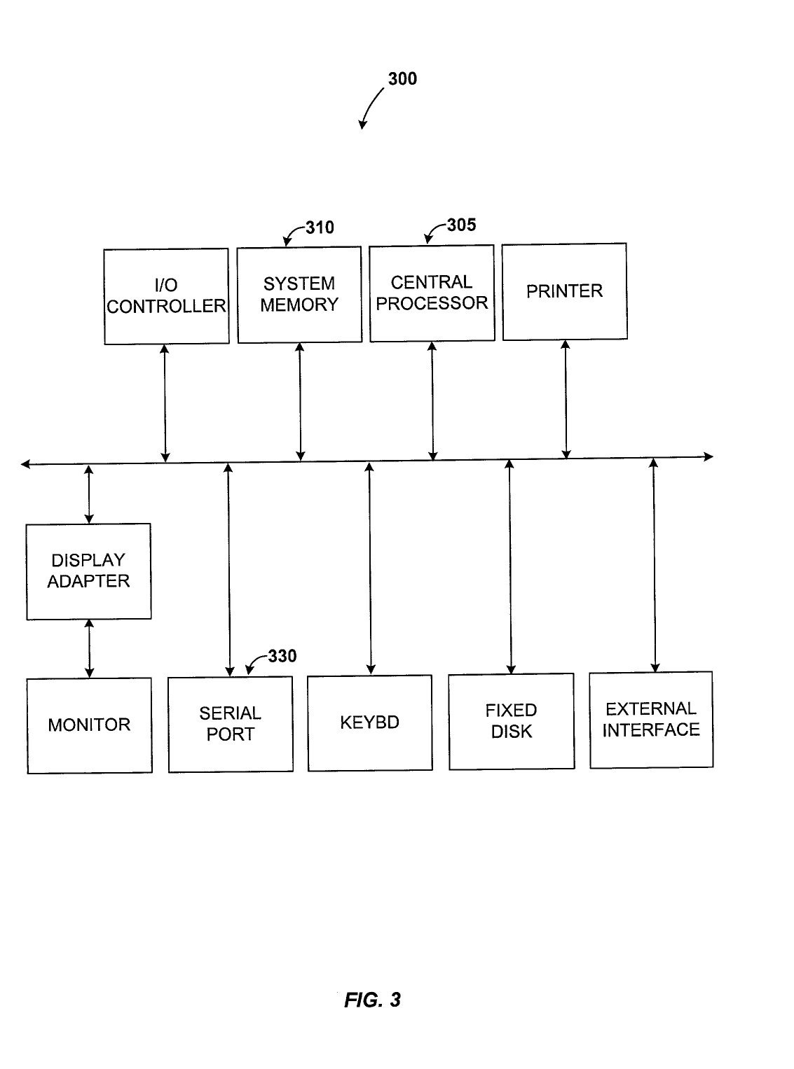

FIG. 3 is an illustration of basic subsystems in computer system 200 of FIG. 2. This diagram is merely an illustration and should not limit the scope of the claims herein. One of ordinary skill in the art will recognize other variations, modifications, and alternatives. In certain embodiments, the subsystems are interconnected via a system bus 320. Additional subsystems such as a printer, keyboard, fixed disk and others are shown. Peripherals and input/output (I/O) devices can be connected to the computer system by any number of means known in the art, such as serial port 330. For example, serial port 330 can be used to connect the computer system to a modem, which in turn connects to a wide area network such as the Internet, a mouse input device, or a scanner. The interconnection via system bus 320 allows central processor 305 to communicate with each subsystem and to control the execution of instructions from system memory 310 or the fixed disk, as well as the exchange of information between subsystems. Other arrangements of subsystems and interconnections are readily achievable by those of ordinary skill in the art. System memory 310, and the fixed disk are examples of tangible media for storage of computer programs, other types of tangible media include floppy disks, removable hard disks, optical storage media such as CD-ROMS and bar codes, and semiconductor memories such as flash memory, read-only-memories (ROM), and battery backed memory.

Information Flow in System

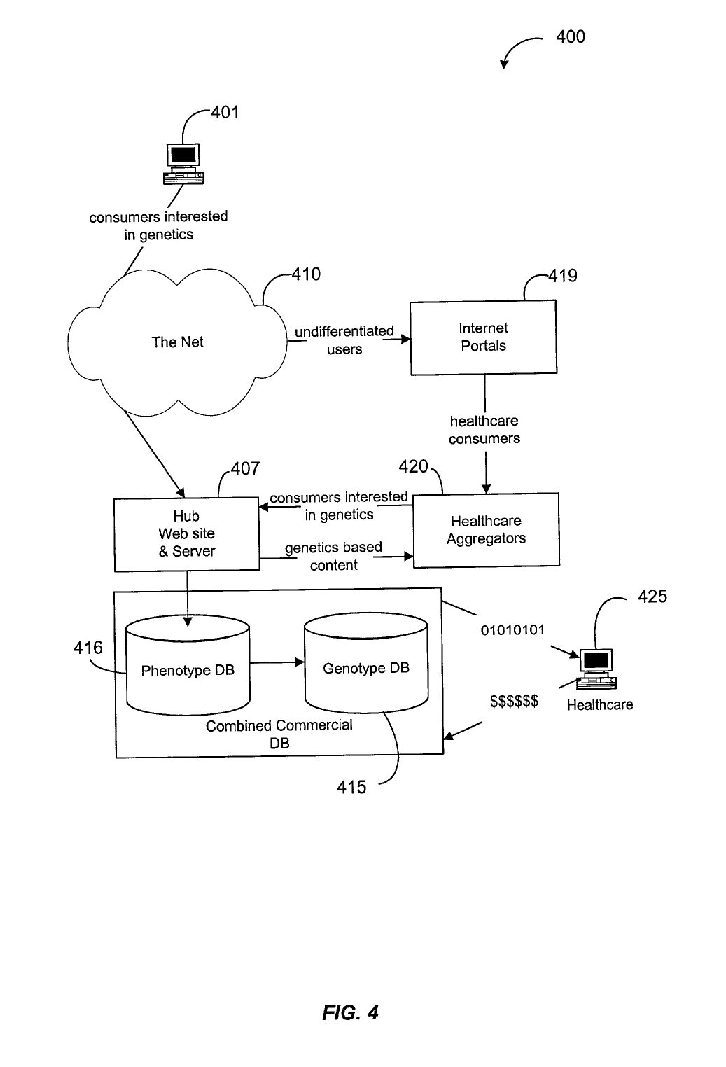

FIG. 4 illustrates a system in which the present invention may be embodied, and illustrates the flow of information in the system. In the illustrated system, a remote user's computer 401 has a web browsing application or the like resident thereon and a server system 407 has a web server application or the like resident thereon. The user's computer 401 includes a communications link for communicating with the host computer 407 either directly or via a wide area network 410. The user's computer 401 and the communications link may be of types similar to user computers 108 and their corresponding communications links as discussed with respect to FIG. 1. Similar to the server system 102 of FIG. 1, server system 407 may comprise one or more computers of a type suitable for hosting a web site. Wide area network 410 may be the Internet.

It is understood that a user's computer having a web browsing application (or the like) resident thereon or a host computer having a web server application (or the like) resident thereon or other apparatus configured to execute program code embodied within computer usable media, may operate as means for performing the various functions and carries out the methods of the various operations of the present invention.

Server system 407 includes a database, similar to database 104 described with respect to FIG. 1, that stores web pages, forms, questionnaires, and the like. Server system 407 disseminates information to computers, such as user's computer 401. In some embodiments, server system 407 disseminates such information via the wide area network 410. In other embodiments, server system 407 may disseminate such information via direct communication links as described above.

The server system 407 is coupled to various databases 415 and 416. The databases 415 and 416 may be of types similar to those discussed with respect to databases 104 and 105 of FIG. 1. In the embodiment shown in FIG. 2, phenotypic data is stored in database 416 and genotypic data is stored in database 415. Databases 415 and 416 may be one database or separate databases. Additionally, the database included in server system 407, described above, that stores web pages, forms, questionnaires, and the like, may include databases 415 and 416. In one embodiment, the database 415 and/or database 416 are secured databases to protect the highly sensitive phenotypic and genotypic information of individuals. In another embodiment, database 415 and/or database 416 are not accessible from the wide area network 410.

System 400 may further include one or more general internet portals 419 as well as one or more healthcare internet portals 420. It is to be understood that, in some embodiments, the wide area network 410 need not be the Internet. Thus, general internet portals 419 and healthcare internet portals 420 may also be referred to as general portals and healthcare (or health) portals, respectively. One or more of the general portals 419 may comprise a first level of subject matter from a plurality of subject matter topics. One or more of the healthcare portals 420 comprises a second level of subject matter that is more specific than the first level of subject matter, the second level of subject matter being of a plurality of medical and/or health related topics. In embodiments in which the wide area network is the Internet, general internet portals 419 may be web sites such as, for example, Yahoo, Lycos, and the like. Additionally, healthcare internet portals 420 may be web sites such as, for example, WebMD, Intelihealth, Dr. Koop, Medscape, and the like.

Each of the general internet portals 419 operates one or more web sites that may provide a wide variety of generalized information and links to a wide variety of web sites that relate to more specific topics of interest. Thus, the general internet portals 419 act to aggregate large numbers of users interested in a wide variety of topics. Each of the healthcare internet portals 420 operates one or more web sites that may provide generalized information relating to a wide variety of medical- and/or healthcare-related topics. Thus, the healthcare internet portals 420 act to aggregate large numbers of users interested in medical-and/or healthcare-related topics.

System 400 may further include one or more subscriber computers 425, which may be of type similar to that of subscriber computers 110 described with respect to FIG. 1. Subscriber computers 425 may be coupled to database 415 and/or database 416 either directly or indirectly, e.g., via server system 407 and/or the Internet 410. Subscriber computers 425 may provide access to information contained in database 415 and/or database 416. In some embodiments, subscriber computers 425 are not provided direct access to databases 415 and 416. Rather, subscriber computers 425 may only access aggregate information in order to protect the sensitive phenotypic and genotypic information of individuals. In other embodiments, subscriber computers 425 may be provided access to an individual's information in database 415 and/or database 416 upon prior approval by the individual. Subscriber computers 425 may be operated by physicians, pharmaceutical firms, diagnostic firms, academic centers, public/government agencies, or the like.

Populating the Database

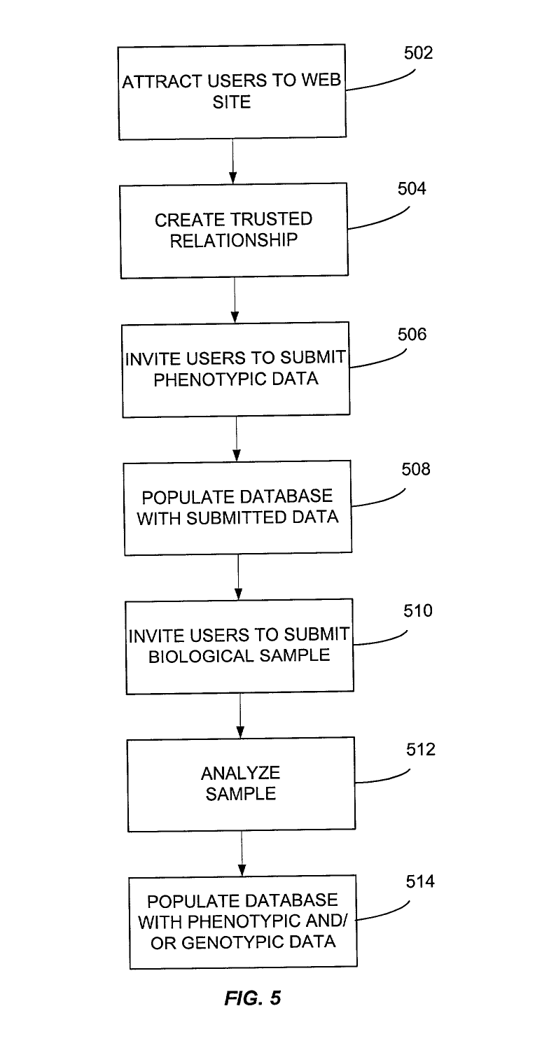

FIG. 5 is a simplified flow diagram illustrating an embodiment of a method according to the present invention. This diagram is used herein for illustrative purposes only and is not intended to limit the scope of the invention. One skilled in the art would recognize many other variations, alternatives, and modifications. The flow illustrated in FIG. 5 may be embodied in a system such as the system 100 illustrated in FIG. 1, the system 400 illustrated in FIG. 4, or the like, but for clarity of explanation, the flow illustrated in FIG. 5 will be discussed only with reference to FIG. 1.

In a step 502, users are attracted to a web site. The web site may be maintained by a server system such as server system 102 of FIG. 1. The web site is a vehicle for inviting large numbers of persons from numerous geographical regions, ethic backgrounds, etc. to provide phenotypic and genotypic data. Such phenotypic and genotypic data is then used to populate a database or databases such as database 105 of FIG. 1.

In one embodiment, the web site provides information relating to genetics, diseases, medical conditions, diseases/medical conditions with a link to genetics, and the like. Persons may be attracted to the web site directly by, for example, registering the web site with one or more search engines. For instance, a person interested in obtaining information on a genetic link to a disease could search on the term “genetics” with an internet search engine provided by a general internet portal (e.g., 401 of FIG. 4). If the web site was registered with the search engine, the search engine would return the URL of the web site to the person. Thus, the probability that the person would visit the web site would be increased.

Additionally, persons may be attracted to the web site via other web sites. For example, links to the web site and information about the web site may be provided on a healthcare internet portal (e.g., 420 of FIG. 4). Thus, a visitor to a healthcare internet portal might see the link and visit the web site. In some embodiments, valuable informational content attributed to the web site may be provided to the healthcare internet portal for posting. A visitor to the healthcare internet portal may appreciate the value of the informational content and be motivated to visit the web site to obtain more such valuable information. Thus, the probability that persons will visit the web site is increased.

The web site is configured to create trusted relationships with visitors to the web site in a step 504. Trusted relationships may be developed over time and interaction with the web site, and the level of trust is a continuum. A trusted relationship may be manifested by, for example, repeated visits to the web site, increasing amounts of time spent interacting with the web site, submission of information to the web site, etc.

In a step 506, users are invited to submit phenotypic information to the server system 102. In one embodiment, a link to a questionnaire is provided on the web site. The questionnaire may query a user on their medical history. As a user's trust of the web site increases and/or if the user's interest is strong enough, the user may access the link to the questionnaire. In another embodiment, if the user has registered with the web site and provided their email address, the web server may email to the user a link to the questionnaire after the web server determines a level of trust has been achieved. The web server may determine a level of trust by, for example, determining a number of times the user has visited the web site, determining a number of times the user has logged onto the web site, etc. Again, the user may access the link to the questionnaire if the user's trust and/or interest strong. Upon completing the questionnaire, the information is transmitted from the user computer 108 to the server system 102 via the Internet 106.

The queries on the questionnaire can include, but are not limited to, date of birth, sex, ethnicity, native language, and diseases and conditions (e.g., Alzheimer's disease, asthma, autism, breast cancer, cardiac arrest, colon cancer, coronary heart disease, Crohn's disease, Diabetes (type I), Diabetes (type II), Eating Disorders (e.g., bulimia, anorexia nervosa), epilepsy, hyperthyroidism, hearing loss, long QT syndrome, lupus, migraine, multiple sclerosis, obesity, Parkinson's disease, prostate cancer, psoriasis, rheumatoid arthritis, ventricular tachycardia and scleredema, osteoporosis, inflammatory bowel disease, melanoma, ovarian cancer, pancreatic cancer, etc.) that the user or user's blood relatives, (mother, father, daughter, uncle, and the like) have been diagnosed by a physician. The queries can also include entries for such items as blood pressure, cholesterol levels, medications, sensitivities to medications, history of drug or alcohol abuse, trauma, weight, and surgical procedures (e.g., heart surgery, kidney removal, gall bladder removal, and the like).

Once received by the server system 102, the information can be used to populate a database (step 508), such as database 105 of FIG. 1. Users may be invited to submit additional phenotypic information, and such additional invitations may be made after trust has increased. Thus, steps 504, 506, and 508 may each be iteratively applied one or more times, as will be described subsequently.

In a step 510, users may be invited to submit a biological sample. The biological sample may be a blood sample, a skin sample, a hair sample, a cheek scraping, a saliva sample, a urine sample, a stool sample, a biopsy, etc. A submitted biological sample may be analyzed for phenotypic as well as genotypic information (step 512), and such phenotypic and genotypic may be used to populate the database (step 514). In one embodiment, an invitation to submit a biological sample is provided on the web site. In another embodiment, if the user has registered with the web site and provided an email address, the user may be invited to submit a biological sample via email. Similarly, the user may be invited via a phone call, fax, letter, etc. Invitations may be provided generally to users, or, as will be described subsequently, users may be selected according to various criteria for individual invitations. As a user's trust of the web site increases and/or if the user's interest is strong enough, the user may accept the invitation. Upon accepting the invitation, the user may be provided with instructions on how to submit the biological sample. Such instructions may be provided via the web site, email, phone, fax, letter, etc. As a user's trust of the web site increases and/or if the user's interest is strong enough, the user may submit the biological sample. In another embodiment, instructions for submitting a biological sample may be generally provided on the web site, generally emailed to registered users, etc.

After the phenotypic and genotypic data derived from the biological sample has been input into the database, users may be invited to submit additional phenotypic information, and such additional invitations may be made after trust has increased. For example, the phenotypic and genotypic data may be analyzed, and, based on that analysis, the user may be invited to submit additional phenotypic data. Thus, steps 506 and 508 may each again be iteratively applied one or more times.

Thus, the information submitted (or derived from submitted biological samples) of many individual users can be used to populate the database. The database can be mined (in a way that protects individuals′ identities) by pharmaceutical companies, diagnostic companies, academic institutions, public/government agencies, or the like. Additionally, the data can be accessed, analyzed, and/or augmented by physicians, health care providers, or the like. These third parties may have access to the database via a subscriber computer 110, or the like.

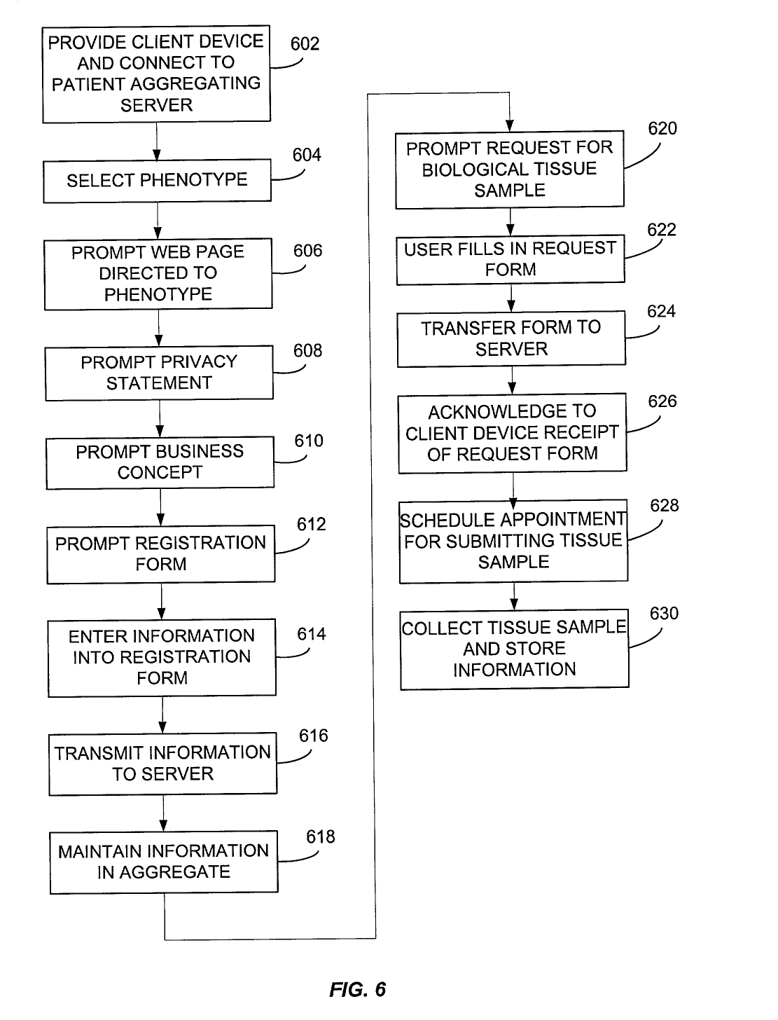

FIG. 6 is a simplified flow diagram illustrating another embodiment of a method according to the present invention. This diagram is used herein for illustrative purposes only and is not intended to limit the scope of the invention. One skilled in the art would recognize many other variations, alternatives, and modifications. The flow illustrated in FIG. 6 may be embodied in a system such as the system 100 illustrated in FIG. 1, the system 400 illustrated in FIG. 4, or the like, but for clarity of explanation, the flow illustrated in FIG. 6 will be discussed only with reference to FIG. 1.

In a step 602, a client device is provided and is connected to a patient-aggregating server through a world wide network via a portal, or a search engine, or browsing, or other techniques. The client device may be a device such as user computer 108, and the patient aggregating server may be a server system such as server system 102. The world wide network of computers may be the Internet 106, and the portal may be a general internet portal, a healthcare internet portal, or the like.

In one embodiment, the patient aggregating server includes sub-sites defined by phenotypic characteristics. Such characteristics may include, but are not limited to, Alzheimer's disease, asthma, autism, breast cancer, cardiac arrest, colon cancer, coronary heart disease, Crohn's disease, Diabetes (type I), Diabetes (type II), Eating Disorders (e.g., bulimia, anorexia nervosa), epilepsy, hyperthyroidism, hearing loss, long QT syndrome, lupus, migraine, multiple sclerosis, obesity, Parkinson's disease, prostate cancer, psoriasis, rheumatoid arthritis, ventricular tachycardia and scleredema, baldness, atrophy, osteoporosis, inflammatory bowel disease, melanoma, ovarian cancer, pancreatic cancer, etc. These subsites may comprise a web site, as described previously, organized around various phenotypic characteristics.

In a step 604, a user selects via an input device (e.g., a mouse) one or more of the phenotypic characteristics, which comprises a plurality of web pages. In one embodiment, a web page served by the patient aggregating server provides buttons, links, a pull-down menu, or the like, so that a user can select a phenotypic characteristic of interest. Additionally, the patient aggregating server provides, for each phenotypic characteristic, a plurality of web pages that provide (or provide links to) one or more of information (e.g., articles, educational materials, etc.), message boards, on-line events, referral services, on-line counseling, tools, etc., related to the particular phenotypic characteristic.

Upon selecting one of the phenotypic characteristics, the patient aggregating server prompts a web page directed to the phenotype characteristic comprising an attribute or branding qualities that has trust and goodwill associated with the phenotype characteristic (step 606). For example, the corresponding web pages of each phenotypic characteristic may be configured to include any of the techniques previously described for creating trust and goodwill.

In a step 608, a privacy statement is prompted to create goodwill and trust between the user and the web site. In one embodiment, a link to the privacy statement is included on many of the web pages served by the patient aggregating server so that a user can readily access the statement.

In a step 610, a business concept is prompted to create further goodwill and trust between the user and the web site. For example, a web page may describe what will be done with information submitted by users (or derived from biological samples submitted by users), who will have access to the information, the revenue sources of operators of the web site, the database, etc.

In a step 612, a registration form with a plurality of fields for input of user information may optionally be prompted. In one embodiment, a registration button, link, etc. is provided on many of the web pages, and the registration form is prompted upon the user selecting the registration button. Additionally, the registration form may be prompted in response to a use attempting navigate to certain parts of the web site.

In a step 614, the user information may be entered into the registration form using the client device. The registration form may, for example, prompt the user for any of the following: a name, address, phone number, e-mail address, etc. Upon completing the form, the user information is transmitted from the client device to the server in a step 616. In a step 618, a plurality of the user information is maintained in an aggregate form without disclosing the name of any one of the users to a third party. For example, the information may be maintained in a database such as database 105.

In one aspect, once trust has been created between the user and the web site, in a step 620, the patient aggregating server prompts a request for a biological sample from the user. The request may be in the form of a web page, email, etc. Alternatively, the request may be in the form of a letter, phone call, etc.

If sufficient trust of the web site has built up and/or if the user's interest is strong enough, the user fills in the request form in a step 622. If the request form was received by the user in an electronic form (e.g., web page, email, etc.), the user may fill in the form using the client device. If the request form was received in a written form (e.g., mail, fax, etc.), the user may fill in the form by hand. If the request from was received in a verbal form, for example, via a phone call, the user may fill in the form by verbally responding to questions posed.

After the request form has been completed, the request form is transferred from the client to the server device in a step 624. If the request form was received by the user in an electronic form (e.g., web page, email, etc.), the user may transfer the form by selecting a button on the web page to transmit the completed form back to the server, email the completed form, etc. If the request form was received in a written form (e.g., mail, fax, etc.), the user transfer the form by mail, fax, etc. Alternatively, the user may bring the form in person to a site designated for such a purpose. Then, the form and/or the responses on the form can be converted into electronic form for transfer to the server. If the request form was received in a verbal form, for example, via a phone call, the user's verbal responses may be converted into electronic form (e.g., voice recognition device). Alternatively, a person communicating with the user may write the user's answers onto a form, enter the responses using a computer device, etc., and, subsequently, the responses on the form are transferred to the server.

In a step 626, receipt of request form is acknowledged to client device. For example, the server may send an acknowledgment email to the client device. Then, in a step 628, an appointment or sampling is scheduled for the user and the schedule is transmitted to the user. For example, the web site may provide a list of locations (e.g., a clinic, hospital, laboratory, etc.) at which the user can submit the biological sample. The web site may also permit the user to schedule an appointment at one of the locations. Alternatively, the web site may provide the user with a link to a web site of one of the locations, a telephone number, an email, etc. by which the user can schedule an appointment directly with the location.

Additionally, the user may be given the option of arranging for submitting the sample at the user's home or office. For example, the web site may permit the user to schedule a visit to the user's home or office from a nurse, technician, or the like to take the user's sample. Also, the web site may include a link, telephone number, email, etc. of a third party so that the user can schedule such a visit directly with the third party. Moreover, the web site may allow user to order material for submitting the biological sample on his/her own. For example, the user may be provided with packing materials in which to ship a biological sample.

In a step 630, the sample is collected from the user and is stored with the user information directed to phenotype information. As will be described subsequently, the biological sample may be analyzed and phenotypic and genotypic information may be extracted in any number of ways well known to those skilled in the art. The information may then be stored in a database, such as database 105. Additionally, the extracted information may be stored with other phenotypic information provided by the user prior to or after the submission of the biological sample.

At any of the above steps, the web site may provide an incentive to the user in order to increase interest in submitting a sample. For example, the web site may offer a chance to win a monetary award, offer frequent flier miles, free or discounted treatment, free or discounted report providing an analysis of their submission, free or discounted genealogical information based on their submission, etc.

The above steps may be repeated for numerous users. Thus, a large, diverse, and valuable database of phenotypic and genotypic information may be created.

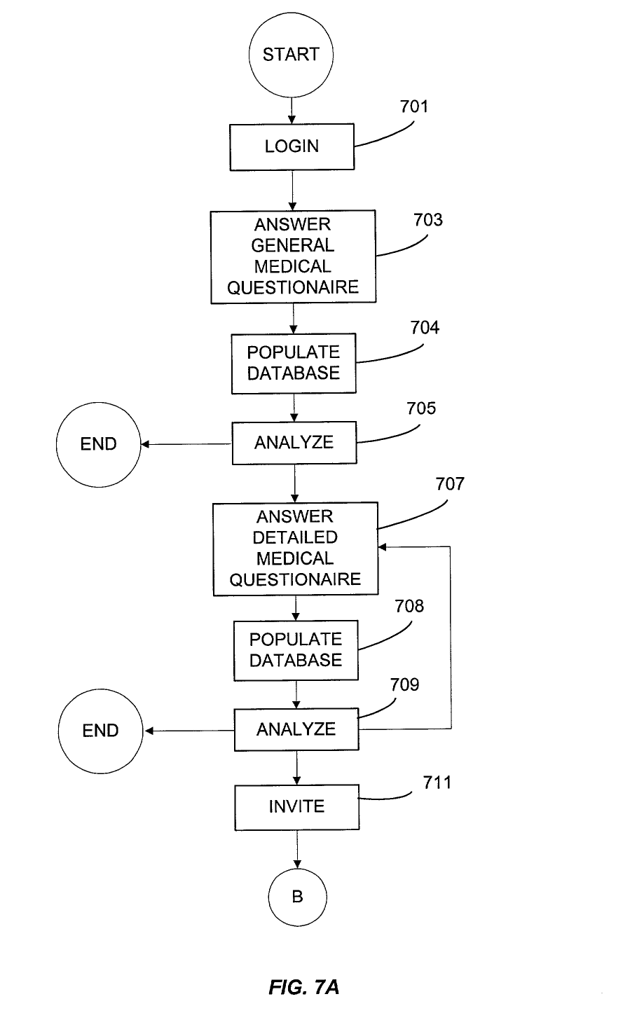

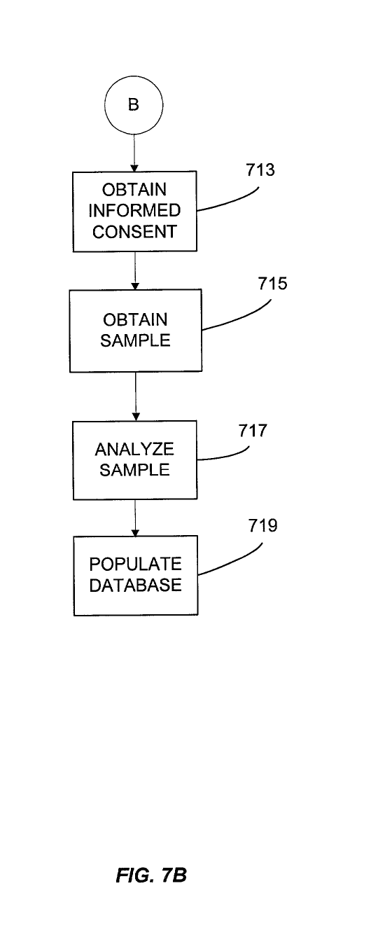

FIGS. 7A and 7B are a simplified flow diagram illustrating yet another embodiment of a method according to the present invention. This diagram is used herein for illustrative purposes only and is not intended to limit the scope of the invention. One skilled in the art would recognize many other variations, alternatives, and modifications. The flow illustrated in FIGS. 7A and 7B may be embodied in a system such as the system 100 illustrated in FIG. 1, the system 400 illustrated in FIG. 4, or the like, but for clarity of explanation, the flow illustrated in FIGS. 7A and 7B will be discussed only with reference to FIG. 1.

In a step 701, server system 102 prompts a user, via user computer 108 and the Internet 106, to login to a secured area of a web site. The login process may occur in any number of well known ways. For example, the user may be asked to enter a previously established login name and a previously established password. In order for a user to obtain a login name and password, the user may optionally be required to formally agree to terms and conditions of the web site. For example, the terms and conditions may provide that web site may store submitted information, including information on medical history, medications, and family's medical history. Also, the terms and conditions may provide that the user may revoke this consent and request that submitted information may be removed at any time in order to promote trust in the web site.

In a step 703, the user is prompted to fill out a general medical questionnaire form on the web site. The queries on the questionnaire can include, but are not limited to, the queries described with respect to step 506 of FIG. 5.

Once completed, the general medical questionnaire form is transmitted to the server system 102 in a manner well known in the art. In a step 704, the information submitted with the completed general medical questionnaire form is stored in a database, such as database 105.

In a step 705, the information transmitted in the completed general medical questionnaire form is analyzed to determine whether to invite the user to submit a biological sample or whether to obtain further information from the user before making a decision to invite. In some embodiments, persons having a particular disease or condition are identified by using an algorithm or filter that analyzes the responses of the received general medical questionnaires to determine whether a particular user meets particular criteria or a closeness-of-fit with predetermined parameters. Based on the analysis, if it is determined that further information from the user is desired, the method proceeds to step 707. Otherwise, the user is not invited to participate.

In step 707, the user is prompted to fill out a detailed medical questionnaire form on the web site. A completed detailed medical questionnaire form is transmitted to the web site server in a manner well known in the art. For example, the detailed questionnaire may ask for information that is pertinent to the further classification of the user in database by querying about the specific disease(s) indicated in the general questionnaire. These additional queries of the user can also include, without limitation, asking the user to indicate if they are under a physician's care for a particular disease and if they are currently taking medications used to control or treat the indicated disease or condition. For example, users that are in generally good health, except for the existence of high blood pressure may be asked to provide more detailed information that is relevant to cardiac disease in order to identify populations of the users that could benefit from new pharmaceuticals targeting high blood pressure, and/or could benefit from information or enrollment in a clinical trial on high blood pressure. Also, for example, users that are suffering (or are likely to suffer) from asthma, may be asked to provide further information that is relevant to asthma. In the case of asthma, relevant queries could include questions or entries for smoking, wheezing, birth weight, coughing, short of breath, hay fever, allergic, skin test to test for allergies, results of a breathing test for asthma (e.g., the FEV1—the first expiratory volume), other lung problems, or whether the user is currently taking any medication such as Albuterol, Proventil, Ventolin, Serevent, Theo-dur, Unidur, Slo-bid, Intal, Tilade, Singulair, Accolate, Zyflo, Beclovent, Vanceril, Aerobid, Pulmicort, Flovent, Azmacort.

Once completed, the detailed questionnaire form is transmitted to the server system 102 in a manner well known in the art. In a step 708, the information submitted with the completed general medical questionnaire form is stored in a database, such as database 105.

In a step 709, the information transmitted in the completed detailed medical questionnaire form is analyzed. In one embodiment, the information is analyzed to determine whether or not to invite the user to submit a biological sample. In another embodiment, the information is further analyzed to determine whether additional information is needed before making a decision. If so, the method reverts back to step 707 where the user is prompted to fill out another detailed medical questionnaire form on the web site.

In yet another embodiment, the information may be analyzed to determine whether answers to the questionnaires are likely to be incorrect, either intentionally or unintentionally. For example, an algorithm may analyze and compare information obtained via a detailed questionnaire with information obtained via the general medical questionnaire and/or other detailed medical questionnaires to determine the accuracy of the submitted information. Based upon the determined accuracy, the user may not be invited to submit a biological sample, for example, if it is likely that answers on the questionnaire are incorrect. If it is determined to invite the user to participate, the method proceeds to step 711.

In step 711, the user is formally invited to participate. The invitation may take the form of a phone call, mail, email, or the like. In one embodiment, the invitation may direct the user to proceed to a secured area of the web site, using the user's login name and password. In another embodiment, the user may be asked to establish another login name and/or password to obtain access to the secured area of the web site.

Referring now to FIG. 7B, in a step 713, an informed consent of the user is obtained before the user may participate. In one embodiment, the secured area of the web site may provide instructions to the user for executing an informed consent form. Additionally, the web site may provide an informed consent form for preview by the user. In one embodiment, the user may be required to execute the informed consent form in the presence of a person. The person may be a representative or agent of the database operator. In another embodiment, the person may be a third party. The person may attempt to verify the identity of the user. Additionally, the person may attempt to verify that the user is adequately informed. In another embodiment, the user may execute the informed consent form electronically via, for example, a digital signature, encryption, or the like. In this embodiment, a person as described above may communicate with the user via telephone, email, internet, and the like. In yet another embodiment, the user may execute the informed consent form not in the presence of, or without verification by, the person described above.

In a step 715, a biological sample is obtained from the user. The user may be instructed to go to a specific location. Also, the user may be given the option of arranging for submitting the sample at the user's home or office. The web site may include a list of sample submission options, locations, phone numbers, instructions, and the like. Additionally, the user may obtain the sample him/herself and then transport the sample to a location.

In a step 717, the biological sample is analyzed using any one of numerous methods known in the art. In a step 719, the information obtained from the analysis is used to populate a database, such as database 105.

Analyzing the Biological Samples

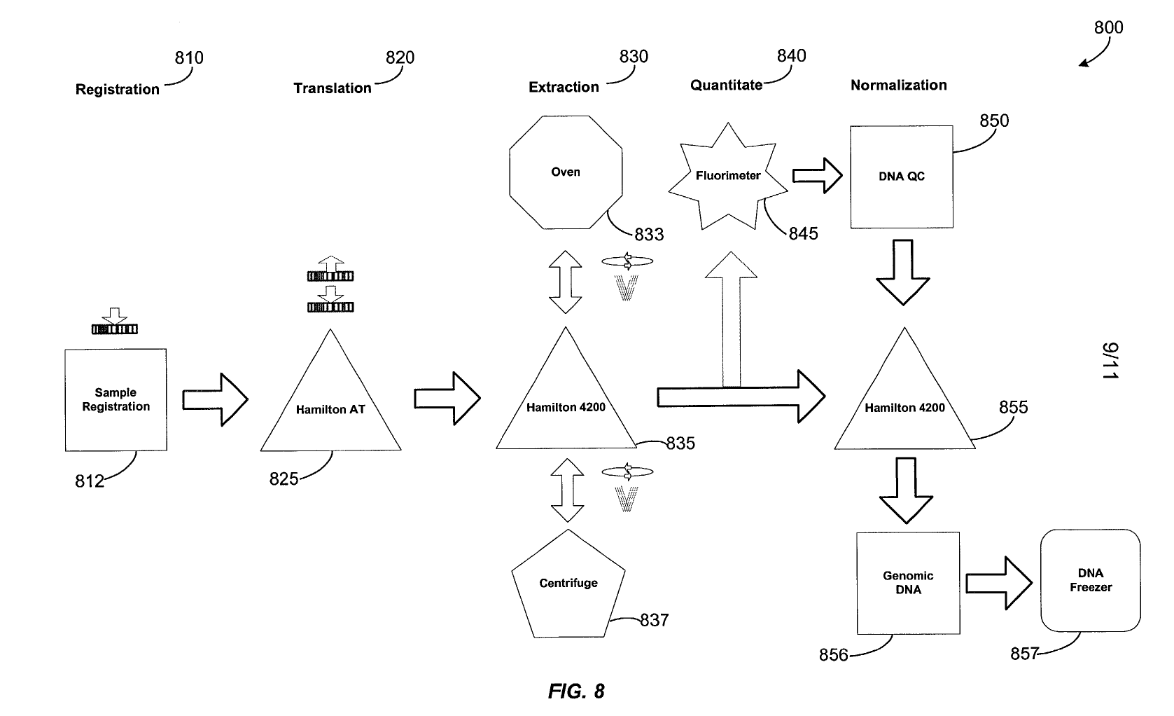

FIG. 8 is a simplified flow diagram 800 for analyzing a biological sample from a user according to another aspect of the present invention. This diagram is merely an example, which should not unduly limit the scope of the claims herein. One of ordinary skill in the art would recognize many other variations, alternatives, and modifications.

In certain aspects of the present invention, users provide a biological sample for analysis. The analysis can then be used to populate a database, such as database 105 of FIG. 1, with phenotypic and/or genotypic information associated with the user. The information in the database related to the user may be referred to as the user's profile. The profile may include information submitted by the user as described previously.

An individual's biological sample can include, but is not limited to, blood, serum, saliva, a cheek scraping, cells, hair, skin, biopsy material (e.g., of a tumor, organ, tissue, and the like), urine, stool, and the like. In certain aspects, the biological sample is analyzed for the presence and nature (e.g., chemical structure) of a variety of biomolecules (e.g., proteins, peptides, carbohydrates, cholesterol, RNA, DNA, nucleic acids, mitochondria DNA, and the like). Of particular interest are biomolecules that are important markers or indicators for disease diagnosis or prognosis. Biomolecules will typically be analyzed to provide phenotypic or genetic information through biochemical assays.

In certain embodiments, the process of analyzing the sample begins with registration 810. Registration 810 embodies the process of receiving a biological sample such as blood, or DNA sample(s), in an individual tube with an external sample ID, either in the form of a barcode or another annotation (handwritten, typed, and the like) attached to the individual tube. This ID is entered into a database and the sample is associated with other information (disease status, drug therapy, phenotype, behavior, family history, and the like) that is received concurrently or has already been received in an electronic format and is entered into a database. Preferably, an internal barcode ID is attached to each sample 812 after the sample is entered into the database. The registration step is typically achieved at a computer workstation with a barcode reader and a barcode printer, and preferably, in a networked environment.

In this embodiment, analysis then proceeds to the next step or the translation step 820. Translation 820 is the step whereby an individual sample, such as blood or DNA, is added to an array of multiple samples, e.g., an array of up to 96 samples, in an 8×12 array. This “plate” of samples is then given a unique ID, whereby any single sample is then associated with both the plate and a particular coordinate within the plate (e.g., well B3). This can be achieved automatically such as by a Hamilton AT2 robot 325 integrated with a barcode reader.

Extraction 830 is typically the next step in polymorphic profile determination. Extraction 830 is the step whereby reagents are added to the blood samples to disrupt the cells, and remove the proteins, sugars, salts, RNA, and the like The resulting product is purified DNA. In certain instances, the sample received in the registration step 810 is already purified DNA, instead of a raw sample (e.g., blood sample), thus the extraction step 830 is omitted. In a preferred embodiment, the extraction step 830 is done automatically using robotic armature such as with a Hamilton 4200 MPH-8 robot 835 for reagent addition steps, an oven for incubation steps 833, and a centrifuge for purification steps 837.

In certain aspects, the next step in the analysis is a quantitation step 840. In this process step, the concentration and purity of DNA for a particular sample is measured. This can be achieved by a variety of methods, including, but not limited to, absorbance at 260 and 280 nm or by fluorescence measurement of DNA-binding dyes. Quantitation can be accomplished using various analytical instrumentation such as a spectrophotometer (for absorbance readings) or a fluorometer 845 (for fluorescence readings).

Following quantitation 840, in certain aspects, the next step is normalization 850. In the normalization step 850, samples are diluted with a buffer to a standard concentration. After the extraction process, the samples have various concentrations, often between the range of 5-40 ng/L. Samples will all be normalized to a concentration of approximately 10 ng/L (+/−20%), except for samples below a threshold, which will be re-queued to repeat the above process. This step can be done on a Packard Multiprobe robot 855. Thereafter, the genomic DNA sample 856 is placed in a freezer 857 to ensure sample stability. The presence or absence of various alleles predisposing an individual to a disease is determined. Results of these tests and interpretive information can be returned to a health care provider for communication to the tested individual, to the individual directly, and/or used to augment the user's profile in the database. Diagnostic laboratories can perform such diagnoses, or, alternatively, diagnostic kits are manufactured and sold to health care providers or to private individuals for self-diagnosis.

A) Phenotypic Assays of Biological Samples:

A biological sample can be assayed for a variety of phenotypic characteristics and disease indicators. For example, blood can be analyzed for hemoglobin content, glycosylated hemoglobin (a diabetes marker), total cholesterol, HDL cholesterol, LDL cholesterol, white blood cell count, blood urea nitrogen, alkaline phosphatase, serum creatine, white blood cell make-up (e.g., T-cell content, macrophage content, and the like), bilirubin, SGOT(AST) (serum glutamic-oxaloacetic transaminase), SGPT (ALT) (serum glutamic-pyruvic transminase), hematocrit, red blood cell count, albumin, total protein, glucose, calcium, inorganic phosphate, potassium, sodium, uric acid, and the presence of antibodies against a particular protein (e.g., anti-HIV antibodies, anti-gp120 antibodies, and the like). Urine can be analyzed for a variety of parameters, including, but not limited to, specific gravity, pH, glucose, total protein, hemoglobin, and the presence of a particular protein. If the biological sample is a biopsy from a tumor, then the tumor can be analyzed for the presence of cells whose morphology or biomolecule makeup (e.g., BRCA1 for breast cancer) is consistent with a metastatic or cancerous state. Those of skill in the art will recognized a plethora of clinical markers and biomolecules and methods for determining their presence and content. In addition, the biological sample can be analyzed for the presence, identity, or nature of an infective entity (e.g., bacteria, virus, prion, fungus, parasite, and the like).

A biological sample can be analyzed using methods and assays that are known in the art. Examples of methods include, but are not limited to, mass spectrometry, immunoassays, radiometric assays, electrochemical assays, spectrophotometric assays, chromatographic assays, and the like. In some embodiments of the invention, methods that permit high-throughput analysis such as solid phase assays (e.g., analytical reagents immobilized on a solid surface or substrate, and the like), immunoassays and enzymatic assays are used to analyze the biological samples.

The results of such assays can be embodied in a data set and entered or transmitted to the database. In certain aspects, data is collected from a temporal series of samples used to construct a temporal data profile of parameters being assayed (e.g., total cholesterol, HDL cholesterol, LDL cholesterol, and the like) in order to detect changes over time that may be relevant to the classification of the user in a particular subpopulation.

In some cases, the determination of the structure of a biomolecule's phenotype can provide information as to the genotype. For example, it may be possible through immunoassays or protein characterization (e.g., mass spectrometry, amino acid sequencing, and the like) to infer what the genetic makeup was that gave rise to that particular protein sequence.

The data resulting from a phenotypic assay of an individual can be aggregated with the results of phenotypic assays from other individuals. In some embodiments, the phenotypic assay data can be used to further populate the user's profile database.

B.) Genotype Assays of Biological Samples:

The genotype of a user can be determined from a biological sample through the analysis of the user's nucleic acids. In some embodiments, the genotype of an infective entity (e.g., bacteria, virus, prion, fungus, parasite, and the like) in a biological sample (e.g., from a subject infected with a pathogenic virus) can also be assayed. The analysis of a user's genotype and their genetic polymorphisms can be critical in the diagnosis and/or treatment of a disease and for the discovery of previously unknown genes or gene defects that give rise to a particular pathology.

Genetic polymorphisms such as restriction fragment length polymorphisms (RFLPs), short tandem repeats (STRs), variable number tandem repeats (VNTRs), and single nucleotide polymorphisms (SNPs) are known in the art. These polymorphism can give rise to defects in the expression or function of a gene and its related product which can contribute in whole, or in part, to the manifestation of a disease, syndrome or condition. There are many SNPs that are known in the art (see Table I in WO 93/452,633) and many are available on the worldwide web. For example as of Aug. 21, 2000, the SNP consortium, had 296,990 SNPs mapped to the human genome (see http://snp.cshl.org/and http://snp.cshl.org/db/snp/map).

In some cases diseases or conditions already have genetic markers or defects in particular genes/loci that have been implicated, at least in part, in giving rise to the disease or condition (see Table I in WO 93/452,633). In the case of breast cancer, for example, variations in genes such as BRCA1 and BRCA2 have been implicated as important predictors of the risk of contracting breast cancer. For diabetes, polymorphisms in genes such as insulin, the insulin receptor, NIDDM1, NIDDM2, NIDDM3, HNF4A, GLUT4, NEUROD1, MAPK8IP1 (Mitogen-Activated Protein Kinase 8-Interacting Protein 1), and mitochondrial tRNA-Leu have been shown to be important components for the manifestation of the disease. For Long QT syndrome, genetic variations in genes for KVLQT1 (LQT1), HERG (LQT2), SCN5A (LQT3), LQT4, KCNE1 (LQT5), and KCNE2 (LQT6) have been thought to be important diagnostic indicators. Also, variations in genes for presenilin 1, presenilin 2, and beta amyloid precursor have been linked to the early-onset of Alzheimer's disease. Other variations in genes such as apo lipoprotein E and alpha-2 macroglobulin have been thought to be linked to late-onset Alzheimer's disease. Additionally, genetic variations in the APC (Adenomatous Polyposis of the Colon) gene have been implicated in the manifestation of familial adenomatous polyposis (FAP), an inherited form of colorectal cancer. Subjects suffering from another form of inherited form of colorectal cancer, non-polyposis colon cancer (HNPCC) have exhibited genetic polymorphisms in genes such as hMSH2, hMLH1, hPMS1, and hPMS2. The foregoing is not an exhaustive list of diseases and conditions and examples of genes and loci that are important for the diagnosis and prediction of developing the associated pathologies. Those of skill in the art will recognize a wide variety of other diseases and conditions as well as genetic variations that are thought to give rise to a particular disease(s).

Assays for analyzing genetic polymorphisms and analyzing nucleic acid sequences are well known in the art (see e.g., USSN 09/452,633 filed Dec. 1, 1999 and Current Protocols in Molecular Biology (Ausubel et al., eds., 1994)). In general, these assays involve contacting a nucleic acid with a biochemical reagent(s) to produce a signal that renders information about the structure of the nucleic acid. Methods such as DNA sequencing, gel electrophoresis, PCR, RT-PCR, amplification methods, gene chips, and the like, can be used alone or in combination to provide genetic information. In some embodiments of the invention, methods that permit high-throughput analysis such as nucleic acid amplification methods (e.g., PCR, RT-PCR, and the like), gene chips, protein chips, immunoassays and enzymatic assays.

The results of these genetic assays can be embodied in a data set and transmitted or entered into a database, such as database 105 of FIG. 1. Through the use of algorithms and filters, links between genetic variations at one or more loci can be correlated with the incidence or prevalence of a particular disease or condition. Thus, in some embodiments of the invention, links between genetic variations and disease states can be uncovered.

The Database

The data in the database may be classified. For example, an algorithm can be used to identify users that are in generally good health, except for the existence of high blood pressure. Such users could then be asked to provide more detailed information that is relevant to cardiac disease to identify populations of users that could benefit from new pharmaceuticals targeting high blood pressure, and/or could benefit from information or enrollment in a clinical trial on high blood pressure. Such high blood pressure subpopulations can also be candidated for genetic studies of hypertension and cardiac disease.

Also, with the data included in the database, it is possible to generate comparisons and associations between phenotypic data and genotypic data, amongst phenotypic data, amongst genotypic data and any combination thereof. For example, the user information directed to the phenotype information and the information contained in the biological sample (e.g., protein levels (e.g., quantification), RNA levels, DNA variations (e.g., single nucleotide polymorphisms and mutations)) in the database is stored and aggregated. The aggregated information can be queried using various algorithms and useful correlations may be obtained.

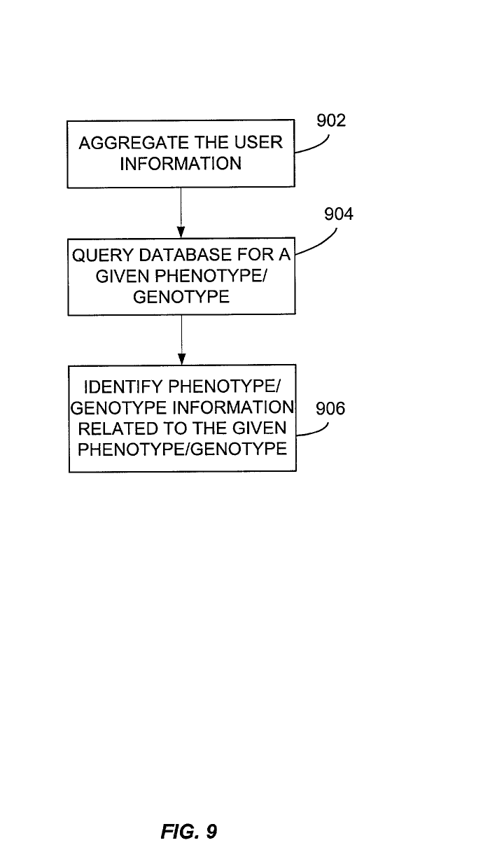

For example, correlations between a disease, medical condition, etc. and phenotypes and/or genotypes may be uncovered. FIG. 9 is a simplified flow diagram illustrating a method according to yet another aspect of the present invention. This diagram is used herein for illustrative purposes only and is not intended to limit the scope of the invention. One skilled in the art would recognize other variations, alternatives, and modifications. The flow illustrated in FIG. 9 may be embodied in a system such as the system 100 illustrated in FIG. 1, the system 400 illustrated in FIG. 4, or the like.

In a step 902, the user information directed to the phenotype information and the biological (e.g., blood sample) information in the database is aggregated. For example, users having a disease, medical condition (e.g., heart disease, asthma, etc.), etc., users having a particular gene, mutation, SNP, etc., users having a particular RNA level, protein level, hormone level, etc., can be aggregated into populations. One skilled in the art will recognize many other useful ways to aggregate the database.

In a step 904, the database is queried for a given phenotype (or a given biological trait) to correlate the biological information. For example, the database may be queried for users having asthma or having indications of asthma.

In a step 906, the biological information or portion of the biological information or any relationship to the biological information (or phenotype information) related to each other for the given phenotype (or given biological information) is identified. For instance, it may be possible to find correlations between phenotypes and genotypes of certain individuals. As is known to those skilled in the art, many different algorithms may be used to uncover such correlations. Such algorithms include, but are not limited to, general liner models, non-linear regressions, analysis of variance, fuzzy logic, neural networks, maximum likelihood techniques, contingency table analysis or tests, commercial algorithms and statistics. It is possible to find useful patterns between the user's profile directed to the phenotype information with the information contained in the biological sample (e.g., protein levels, RNA level variations, DNA variations) to identify trends, patterns, linkages, associations, sub-groups, in the data. Moreover, through such techniques as genetic linkage analysis, chromosome walking, SNP mapping, polymorphism mapping, and the like, it is possible to determine what genetic variations in a user's genome gives rise to a particular disease or condition.

Steps 902-906 may repeated for other phenotypes (or other biological information).

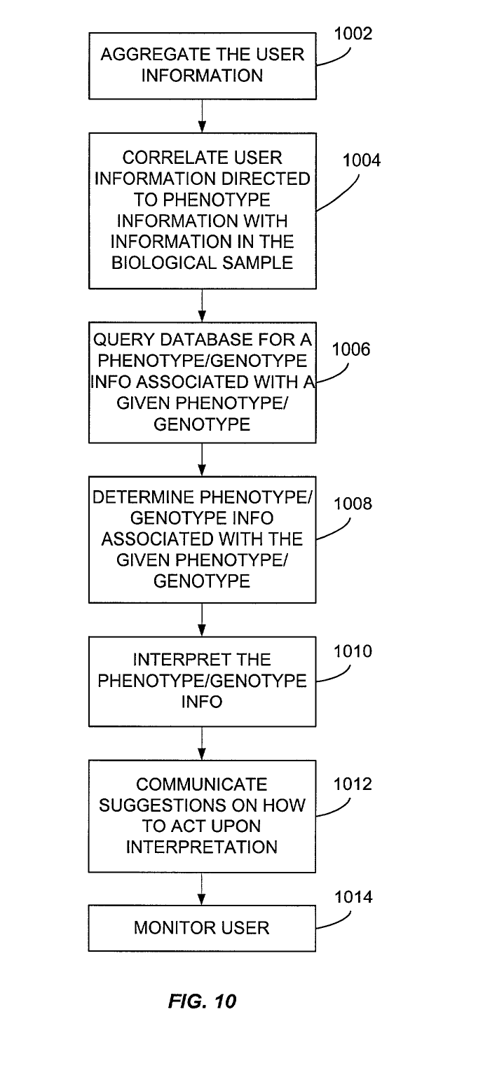

FIG. 10 is a simplified flow diagram illustrating a method according to another embodiment of the present invention. This diagram is used herein for illustrative purposes only and is not intended to limit the scope of the invention. One skilled in the art would recognize many other variations, alternatives, and modifications. The flow illustrated in FIG. 9 may be embodied in a system such as the system 100 illustrated in FIG. 1, the system 400 illustrated in FIG. 4, or the like.

In a step 1002, the user information directed to the phenotype information and the biological information in the database is aggregated. In a step 1004, the user information directed to the phenotype information is correlated with the information contained in (or derived from) the biological sample (e.g., protein levels, hormone levels, RNA level variations, DNA variations (e.g., genes, SNPs, mutations) in the database to identify trends, patterns, linkages, associations, sub-groups, etc., in the data.

In a step 1004, the database is queried for a phenotype, phenotypes, or biological information associated with a given phenotype or phenotypes, biological trait, genotype, etc. In a step 1006, the phenotype, phenotypes, or biological information associated with a given phenotype or phenotypes, biological trait, genotype, etc., are determined. For example, certain protein levels, SNPS, may be associated with heart disease. Additionally, levels of stress, eating habits, amount of exercise, etc. may also be associated with heart disease. Thus, if the database were queried for a heart disease phenotype, such associations may be determined.

In a step 1008, the phenotype, phenotypes, or biological information associated with a given phenotype or phenotypes, biological trait, genotype, etc., may be interpreted. In the example of heart disease, it

In a step 1010, suggestions may be communicated to a user on how to act upon the interpretation. The suggestions may be shown on a web page when the user logs onto the web site, emailed, mailed, communicated via phone call, sent as a report to the user's physician, sent as a report to a family member, etc. For example, if a user's profile indicates heart disease and high cholesterol levels, suggestions may include a course of treatment, how to lower cholesterol levels, etc., and may be e-mailed to the user.

In a step 1012, the user may be monitored based upon the suggestions. Such monitoring may occur via sensors, movement, questions, requests, feedback, etc. In the heart disease example, the user may be e-mailed questions from time to time regarding the user's amount of exercise. Also, the user may be requested to send periodic blood samples (or communicate results of blood sample analyses) so that cholesterol levels may be monitored.

Steps 1002-1014 may be repeated for other phenotypes, biological information, or genotypes.

In yet another embodiment, candidates are selected for clinical trials through the use of algorithms that select potential clinical trial candidates through criteria embodied in an algorithm for certain genetic and or phenotypic criteria. For example, if a certain genotype is linked to a bad side effect for a particular test pharmaceutical, those individual are selected out of the clinical trial. In other embodiments, the analysis provides information on the best course of treatment for a particular aggregated group or drug regimen based on analysis of the data.

The aggregated group can be contacted for additional study or information. For instance, clinical trials are conducted during the regulatory process to gain approval by a pharmaceutical regulatory agency (e.g., FDA) or after approval for marketing or further study. In an initial stage, such trials involve administering experimental drugs to humans on a small number of healthy volunteers to determine the safety, side effects, dosage levels, mechanism of action, and pharmacokinetics, and the like, of the experimental drug (e.g., Phase I trials). If the experimental drug passes the Phase I trial stage, a Phase II trial is typically conducted. A Phase II clinical study involves a larger patient population such as an aggregated group, and is primarily directed at determining whether the experimental drug is effective at treating the indication(s) being analyzed in the trial. Phase II trials also involve looking at the side effects, adverse events, and safety profiles of the drug. In a Phase III study, the drug is typically tested on a larger sample group than the Phase II trial (e.g., hundreds to thousands of patients). Phase III trials provide a more extensive and in-depth picture of the safety, effectiveness, benefits, adverse event profile, and the like of the particular experimental drug. Post-approval trials, such as latter stage Phase III or Phase IV studies, can be used to compare one or more indices such as the safety, effectiveness, health benefits, cost benefits, long-term effectiveness with another pharmaceutical used to treat the same or similar indication.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A method for populating a database for further medical characterization through a world wide network of computers, the method comprising:
populating a database with a plurality of user health information from a plurality of users, the user health information including genetic data and phenotypic data for a user;
wherein the database is populated at least in part through browsing activities of the plurality of users on the world wide network of computers.

2. The method of claim 1 further comprising inquiring for biological material from each of the users.

3. The method of claim 1 further comprising inquiring for phenotypic information from each of the users.

4. The method of claim 1 further comprising transmitting aggregated health information back to one of the users, the aggregated health information being derived from a group of the plurality of the users.

5. The method of claim 1 further comprising transmitting to one of the users individual health information of the one of the users.

6. The method of claim 1 further comprising transmitting to a third party designated by one of the users individual health information of the one of the users.

7. The method of claim 1 further comprising transmitting aggregated health information to a third party.

8. The method of claim 7 wherein the third party is an educational institution.

9. The method of claim 7 wherein the third party is a research organization.

10. The method of claim 7 wherein the third party is a pharmaceutical company.

11. A system for populating a database for further medical characterization through a world wide network of computers, the system comprising:
a module for populating a database with a plurality of user health information from a plurality of users, the user health information including genetic data and phenotypic data for a user;
wherein the database is populated at least in part through browsing activities of the plurality of users on the world wide network of computers.

12. The system of claim 11 further comprising a module for inquiring for genetic material from each of the users.

13. The system of claim 11 further comprising a module for inquiring for phenotypic information from each of the users.

14. The system of claim 11 further comprising a module for transmitting aggregated health information back to one or more of the users, the aggregated health information being derived from a group of the plurality of the users.

15. The system of claim 11 further comprising a module for transmitting to one of the users individual health information of the one of the users.

16. The system of claim 11 further comprising a module for transmitting to a third party designated by one of the users individual health information of the one of the users.

17. The system of claim 11 further comprising a module for transmitting aggregated health information to a third party.

18. The system of claim 17 wherein the third party is an educational institution.

19. The system of claim 17 wherein the third party is a research organization.

20. The system of claim 17 wherein the third party is a pharmaceutical company.

21. A method for populating a database with phenotypic data and genotypic data of a plurality of users for further medical characterization through a world wide network of computers, the method comprising:
inquiring for phenotypic data from each of a plurality of users;
inquiring for biological material from a subset of the plurality of users;
populating a database with received phenotypic data;
populating the database with genotypic data derived from received biological samples; and
aggregating the phenotypic data and genotypic data.

22. The method of claim 21 further comprising populating the database with phenotypic data derived from the received biological samples.
